(19) United States
(12) Patent Application Publication
(10) Pub. No.: US 2023/0306873 A1
(43) Pub. Date: Sep. 28, 2023

(54) SYSTEMS, METHODS AND APPARATUSES FOR A TRAINING MANIKIN

(71) Applicant: Prestan Products LLC, MAYFIELD VILLAGE, OH (US)

(72) Inventors: Timothy E. Lint, North Royalton, OH (US); Christopher M. Charlton, Mint Hill, OH (US)

(21) Appl. No.: 18/020,054

(22) PCT Filed: Aug. 5, 2021
(86) PCT No.: PCT/US21/44848

§ 371 Date: Feb. 6, 2023

Related U.S. Application Data
(60) Provisional application No. 63/061,703, filed on Aug. 5, 2020.

(51) Int. Cl. G09B 23/28; G09B 23/32

(52) U.S. Cl. CPC G09B 23/288; G09B 23/32

(57) ABSTRACT

A CPR training manikin is provided. The manikin can have a size and shape of the torso area of a human, including a head and a chest area. The head and chest area can be operatively configured to generally mimic a human head, chest, respiratory and cardiopulmonary morphology. Internal to the manikin a chest compression plate is joined to a main compression spring and compressed when chest compressions are applied to the torso area. Electrical circuits can measure, record, and/or report depth of chest compression as well as proper hand placement during chest compression.

### CROSS-REFERENCE TO RELATED APPLICATION

This application claims the benefit of U.S. Provisional Application Ser. No. 63/061,703, filed Aug. 5, 2020, the disclosure of which is hereby incorporated herein by reference in its entirety.

### TECHNICAL FIELD

Embodiments of the technology relate, in general, to systems, apparatuses and methods providing technical solutions for proper CPR training on a manikin.

### BACKGROUND

Currently the American Heart Association (AHA) guidelines do not require feedback devices for proper hand placement during cardiopulmonary resuscitation (CPR) training. However, the AHA lists hand placement as an important component to ensure quality CPR is being performed. Further, the AHA guidelines emphasize the importance of ensuring a proper chest compression depth, and avoiding excessive depths of chest compression.

### BRIEF DESCRIPTION OF THE DRAWINGS

FIG. 1 is a perspective view of a training manikin.

FIG. 2 is a perspective view of the training manikin of FIG. 1 in a compressed state with the upper torso surface in an open position.

FIG. 3 is a cross-sectional perspective view of the training manikin in an uncompressed state taken along the line 3-3 in FIG. 1.

FIG. 4 is a cross-sectional perspective view the training manikin in a compressed state taken along the line 4-4 in FIG. 2.

FIG. 5 is an enlarged sectional view of section 3-3 of FIG. 1 showing the training manikin in a compressed state.

FIG. 6 is a perspective view of an example training manikin.

FIG. 7 is a schematic diagram of exemplary switch positions of the training manikin of FIG. 6.

FIG. 8 is a representative chart of example feedback in a method and system of the present disclosure.

FIG. 9 is a view of an embodiment of the training manikin of FIG. 1 with example visual indicators.

FIG. 10 is a schematic representation of an example visual indicator of FIG. 9.

FIG. 11 is a schematic representation of a visual indicator of FIG. 10.

FIG. 12 is a schematic representation of a visual indicator of FIG. 10.

FIG. 13 is a view of an embodiment of the training manikin of FIG. 1 with example visual indicators.

FIG. 14A is a schematic representation of a visual indicator of FIG. 13.

FIG. 14B is a schematic representation of a visual indicator of FIG. 13.

FIG. 14C is a schematic representation of a visual indicator of FIG. 13.

FIG. 15 is a view of an embodiment of the training manikin of FIG. 1 with example visual indicators.

FIG. 16 is a schematic representation of a visual indicator of FIG. 16.

FIG. 17 is a view of an embodiment of the training manikin of FIG. 1 with example visual indicators.

FIG. 18 is a schematic representation of an example of proper hand placement for the training manikin of FIG. 17.

FIG. 19 is a view of an embodiment of the training manikin of FIG. 1 with example visual indicators.

FIG. 20 is a schematic representation of an example of proper hand placement of for the training manikin of FIG. 19.

FIG. 21 is a schematic representation of an example of proper hand placement of for the training manikin of FIG. 19.

FIG. 22 is a schematic representation of an example of proper hand placement of for the training manikin of FIG. 19.

FIG. 23 is a schematic representation of an example of proper hand placement of for the training manikin of FIG. 19.

FIG. 24 is a schematic representation of a spring operationally connected to a chest compression plate and a bottom compression plate and showing the relationship between spring length and inductance.

FIG. 25 is an example schematic diagram of a modified Colpitts oscillator and analog to digital converter.

FIG. 26 is a representative mechanical implementation of two springs of the circuit.

### DETAILED DESCRIPTION

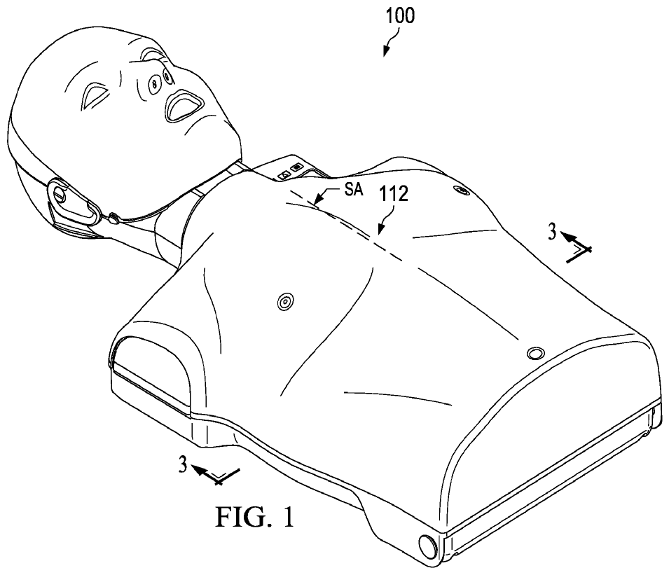

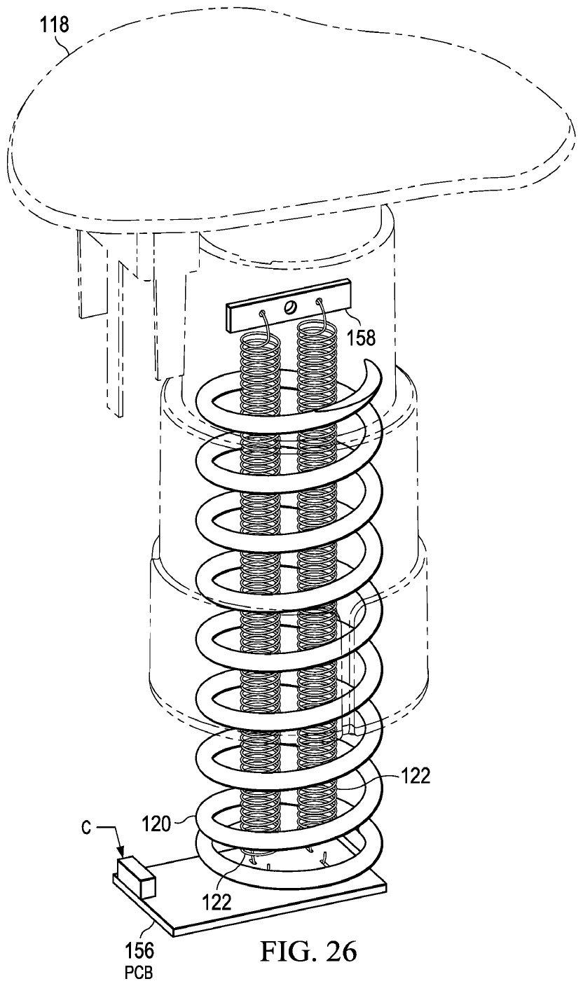

Certain embodiments are hereinafter described in detail in connection with the views and examples of FIGS. 1-26.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Technical solutions to the problems associated with performing proper CPR can be achieved by the systems, apparatuses and methods of the present disclosure. The disclosed systems, apparatuses and methods achieve monitoring and display a representation of hand placement by a person doing CPR on a manikin, and provides feedback as to the correctness of the hand placement.

In general, the systems, apparatuses and methods provide a simple and clear, relatively low cost solution to the problem of training students in proper hand placement during CPR chest compressions. Certain embodiments of the present disclosure are provided herein.

Referring now to FIG. 1, there is shown one embodiment of an apparatus, method and system for training manikin users in proper hand placement during CPR chest compressions. A manikin 100 is provided. The manikin 100 can have a size and shape of the upper torso area of a human, including a head and a chest area. The head and chest area can be operatively configured to generally mimic a human head, chest, respiratory and cardiopulmonary morphology. In general, the manikin 100 can comprise multiple external and internal components, and can have an outer surface that has the look, feel, and shape of the skin of a human. The manikin 100 can include relevant visually distinguished anatomical landmarks, including the sternum, rib cage, sternal notch, and the xiphoid process. An outer surface of the manikin 100 can be vinyl and latex free, being made of relatively durable, lightweight materials. The manikin 100 can have removable outer surfaces, and in one embodiment can be in the form of a clamshell opening configuration (as shown below) for easy access to internal components. The manikin 100 can have an outer skin having portions thinned or otherwise made partially transparent (e.g., opaque) such that visible signals, such as LED lighting (as described below), can be visually detected through the outer skin. An example of a manikin that can be improved by the apparatuses, systems, and methods of the present disclosure is the PRESTAN ULTRALITE® Manikin available from MCR Medical Supply, Inc.

The manikin 100 has an optimal compression force location 112 which represents the optimal place to compress the chest portion of the manikin 100 during chest compressions in CPR training. The optimal compression force location 112 can be understood a location that is provided at a portion of the chest that is situated over the location corresponding to the sternum of the ribcage of a person receiving CPR chest compressions. The optimal compression force location 112 can be located on an imaginary line corresponding to a sternum axis, that is, an imaginary sternum axis SA oriented in line with the approximate center of the sternum. In general, for proper chest compressions, the hands of the person giving CPR chest compressions should be placed such that the sternum, rib cage and chest of the person receiving the CPR compresses uniformly downwardly (toward the surface upon which the person receiving the CPR is laying). Unbalanced forces could result in harm to an actual person receiving such unbalanced forces during compression.

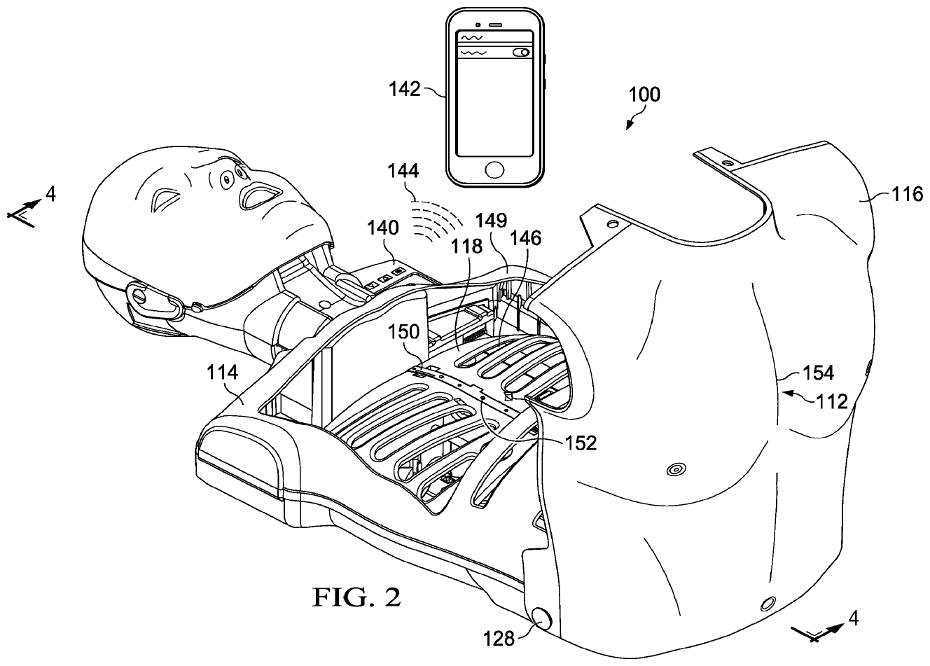

Referring now to FIGS. 1 and 2, the manikin 100 can be provided in a clamshell type arrangement such that an upper torso surface 116 of the manikin 100 can be selectively provided in a closed position (FIG. 1) or an opened position (FIG. 2). When the upper torso surface 116 is in the opened position, as illustrated in FIG. 2, the upper torso surface 116 of the manikin 100 can show and allow access to various internal components. In the illustrated embodiment, a lower torso surface 114 defines an internal cavity in which are placed in operational configuration of various components, including a chest compression plate 118 and one or more springs, including a main compression spring 120 and at least one measuring spring 122, described in more detail below. In FIG. 2 the chest compression plate 118 is illustrated in the compressed position as it would be in use during a chest compression. An upper torso surface 116 is removably connected to the lower torso surface 114. In an embodiment, the upper torso surface 116 is pivotally joined to the lower torso surface 114 by pivot connection 128 about which the upper torso surface 116 can pivot relative to the lower torso surface 114.

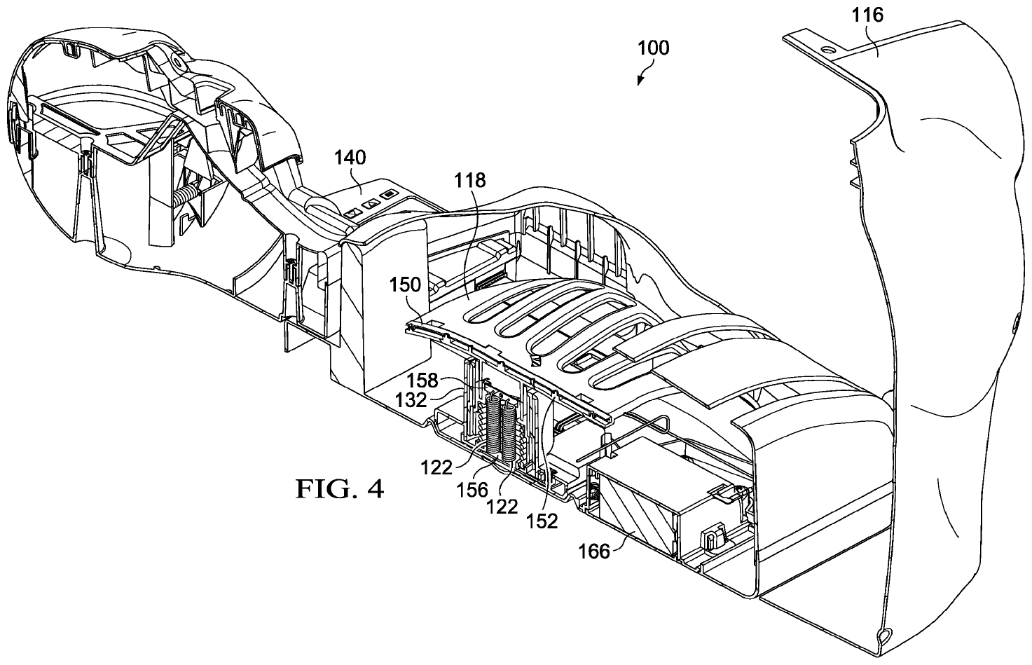

The chest compression plate 118 can generally have a size and shape that approximates a human rib cage. In a central portion of the chest compression plate 118 in an area corresponding to the sternum and being disposed generally linearly aligned to the sternum axis SA (when the upper torso surface 116 is closed) is a sternum printed circuit board assembly (sternum PCBA) 150 on which are operatively joined in electrically-powered communication with a power source a plurality of sternum LED lights 152 and/or switches for indicating proper hand placement during compression. The sternum LED lights 152 and/or switches can be generally evenly linearly disposed about a location corresponding to the optimal compression force location 112, such that upon correct hand placement during compression a predetermined number, e.g., an equal number, of LED lights are visible on each side of the hands performing compression, or in combination or alternatively, an equal number of switches are activated and the result displayed for reading on, for example, a control device 140. A portion of the upper torso surface 116 (e.g., at the sternum axis SA) can be translucent such that light emitted from the sternum LED lights 152 can be visible during hand placement and compressions. In an embodiment, a thinned portion 154 of the upper torso surface 116 generally proximate the area corresponding to the sternum can permit light emitted from the sternum LED lights 152 to be visible to users, trainers, and other associated with the use of the manikin 100. In an embodiment, upon placing the hands on the chest and/or during chest compression, the sternum LED lights 152 can be powered on to be visible through the upper torso surface 116, and visible to the user, a trainer, or others. In an embodiment, when the hands are placed in the proper location, i.e., on the optimal compression force location 112, an equal number of sternum LED lights 152 are visible on each side of the hands. In an embodiment, a user or trainer can utilize the sternum LED lights 152 alone or in combination with a visual display of results shown on an electronic device, such as the control device 140, discussed below. All electrically powered components, including the sternum LED lights and the control device 140, can be powered by a battery 166, as depicted in FIG. 4. Alternatively, the manikin 100, or any of the electrically powered components, can be powered via a mains electric source, such as, for example, a battery or a power cord that is configured to receive power from a wall receptacle.

Further illustrated in FIG. 2 is the control device 140 that can receive, record, analyze, transmit and/or display data including training feedback. The control device 140 can be an electronic device partially or fully embedded into the manikin 100 as shown in FIG. 2. The control device 140 can be directly connected via electrical wiring 146 to the manikin 100, that is, “plugged into” the manikin 100, and disposed in a receiving port 149, such as a slot, in the manikin 100. The control device 140 can be removed manually, that is, by grasping and pulling it away from the rest of the manikin 100. Likewise, the control device 140 can be installed manually, that is, by pushing it into position until the electrical connections are properly seated. Alternatively, removal of the control device 140 can be via an actuator, such as a push-button activated ejector, as is known for the ejection of cassettes in electronic equipment. In addition, or alternatively, the control device 140 can be indirectly connected via wireless technology 144, such as Bluetooth® connectivity to a remote device 142, which can be, for example, a smartphone, as shown in FIG. 2. In an embodiment, a remote device 142 is also the control device 140 and communicates with associated electronic transmissions from the manikin 100 wirelessly The control device 140 can be a programmable device that can be programmed for training scenarios, as well as for recording and displaying feedback to a person being trained. The control device 140 can have memory and a processor that can be programmed with executable instructions to perform any number of predetermined training scenarios and/or feedback data, for example, via various control selectable features. The control device 140 can have a display screen, which can be an LCD display screen, on which can be a display that can show live or real-time graphical or text feedback, show compiled post training performance, and/or make recommendations to the trainee. The LCD screen can also have selectable features that can be the control selectable features. In some embodiments, the control selectable features can be used to navigate various menus and line items that can be used to configure the manikin 100 for certain data analysis related to selected training scenarios. In an embodiment, the manikin 100 can, e.g., via the control device 140, compile training reports. In an embodiment, the data gathered, analyzed, transmitted and/or recorded by the control device 140 can be placed onto external memory devices, such as USB flash drives and/or computer servers and devices. In an embodiment, the control device 140 can have a USB port for data transmission to and/or from the control device 140 and an internal CPU, such as a CPU processor operatively joined to the lower PCBA. In an embodiment, the manikin 100 can have a USB port for data transmission to and/or from the manikin, including internal manikin components and/or the control device 140. The USB port(s) can be used with USB flash drives or other devices, such as a Bluetooth® dongle. The USB port(s) can be utilized to achieve software installation and updates. Wireless communication devices, such as a Bluetooth® dongle can be configured for wireless communication with remote devices such as computers and smartphones.

In some embodiments, a method can be performed using a manikin 100 including the control device 140, as follows. A CPR instructor, technician, or other person, can program a training scenario in the control device 140 by making selections on the display screen. A training scenario can include, or be related to, various criteria associated with CPR training, such as CPR chest compression rate and/or depth training; chest release/recoil timing; number of compressions; timing of compressions, accuracy of recoil; total training session time; ventilation volume; ventilation time; number of ventilations, accuracy of ventilations; hands off time; scoring for all the various measurements. During training, or after a training session is completed, or deemed completed, the trainee and/or instructor can receive feedback in the form of visual feedback on the control device 140 or visual feedback on a remote device in communication with the control device 140 or other components of the manikin. The feedback can also be audible, such as in the form of clicks or tones having meaning to the training session. The method can also include a scoring step in which the desired training criteria is reported with an analysis of the relative scoring criteria. Thus, the methods of the present disclosure can facilitate programmable training sessions that can be easily selected, performed, and reported. The methods can also facilitate real-time and/or delayed feedback on certain predetermined or selectable training criteria. The feedback can include visual or audible feedback via, for example, the control device 140, or a displayed and/or printed report of the training session, including optional scoring of the trainee's CPR session.

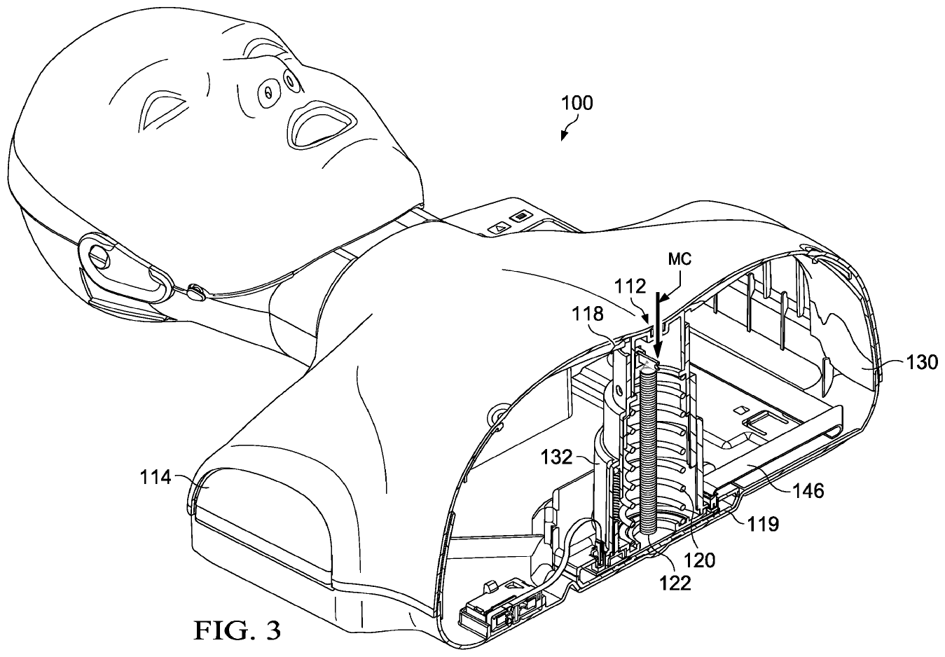

FIG. 3 is a view of cross-section 3-3 of FIG. 1 and shows certain internal components of the manikin 100 when the upper torso surface 116 is in a closed position and operable for use in training. Thus, the upper torso surface 116 is closed and operatively joined with the lower torso surface 114 defining an enclosed cavity 130 in which various components of the manikin 100 are disposed. In FIG. 3 the chest compression plate 118 is illustrated in the uncompressed position as it would be prior to a chest compression.

As depicted in FIG. 3, the manikin 100 can have a bottom compression plate 119 disposed on the lower torso surface 114 opposite the chest compression plate 118. The main compression spring 120 can be a spring operatively situated to resist compression between the chest compression plate 118 and the bottom compression plate 119 in vertical alignment with the direction of main compression MC and aligned with the location associated with the optimal compression force location 112. In an embodiment, the main compression spring 120 is a coil spring having a coil spring axis being longitudinally centered in the coil of the main compression spring 120, and thereby being oriented generally orthogonal to the sternum axis SA. In an embodiment, the coil spring axis intersects the sternum axis SA and is aligned with the direction of main compression MC. In an embodiment, the main compression spring 120 is a coil spring disposed in a telescoping piston sleeve 132 that encloses and protects the main compression spring 120.

Continuing to refer to FIG. 3, when the chest of the manikin 100 is compressed at the optimal compression force location 112, the main compression spring 120 is compressed and the chest compression plate 118 is translated toward the bottom compression plate 119 in the direction of main compression MC. The manikin 100 can include feedback mechanisms, including an audible click, when the chest compression plate is compressed a sufficient and correct distance.

FIG. 4 is a view of cross-section 4-4 of FIG. 2 and shows certain internal components of the manikin 100, including the chest compression plate 118 in a compressed state. As depicted, the upper torso surface 116 is in an open position relative to the lower torso surface 114, thus rendering open what was the enclosed cavity 130 in which various components of the manikin 100 are operationally disposed. The cross-sectional view of FIG. 4 provides for a better view of an example orientation and number of measuring springs 122. In the illustrated embodiment, two measuring springs 122 are disposed internally to the main compression spring 120. Each of the measuring springs 122 are connected at a lower end to a lower spring PCBA 156 and at an upper end to a connector PCBA 158. The measuring springs 122 are metal or electrically conductive, and are electrically connected in series to complete a circuit from lower spring PCBA 156 and through the connector PCBA 158. As discussed more fully below, the inductance characteristics of the measuring springs 122 can be detected to determine length changes of the measuring springs 122, which length changes are used to calculate depth of compression of the main compression spring 120 during compression of the chest compression plate 118 in the direction of main compression MC, as shown in FIG. 3. The measuring springs 122 each joined at a first end by electrical connection to the lower spring PCBA 156 and at a second end to the connector PCBA 158 to make a complete electrical circuit that is in electrical communication with analysis components and the electrical wiring 146 to provide for measuring spring compression data to the control device 140. The two measuring springs 122 are each secured in an electrical connection, such as soldered, that permits a complete electrical circuit through both measuring springs 122 in a series connection.

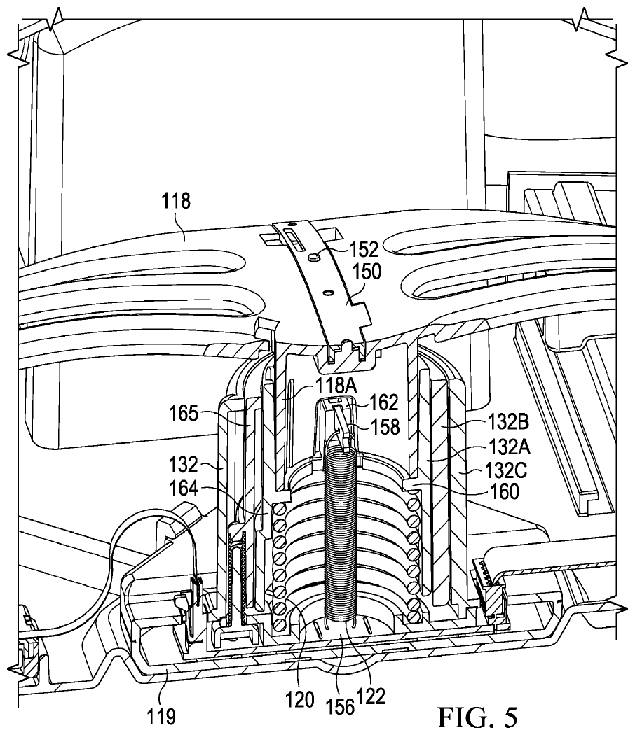

Referring now to FIG. 5, various features of the manikin 100 are shown in greater detail. The chest compression plate 118 can have a plate extension 118A that extends generally orthogonally from bottom surface of the chest compression plate 118 from a generally centrally located portion of the chest compression plate 118 and extends into and is secured to a portion of the telescoping piston sleeve 132. In the illustrated embodiment, the plate extension 118A is generally cylindrically shaped and sized to fit into a generally cylindrically shaped portion of the telescoping piston sleeve 132. In the illustrated embodiment, the telescoping piston sleeve 132 comprises three portions, a first upper portion 132A, a second middle portion 132B, and a third lower portion 132C. The first upper portion 132A is generally cylindrical and can have an inwardly protruding annular extension 160 that acts as a physical barrier upon which the plate extension 118A can rest on one side, and which acts on the other side to compress the main compression spring 120 when the chest compression plate 118 is pressed downwardly. Thus, in an embodiment the outer diameter of the main compression spring 120 can be approximately the same as the inner diameter of the first upper portion 132A. The first upper portion 132A can also have a portion fitted to secure the connector PCBA 158 upon which the measuring springs 122 are connected. Thus, the magnitude of the change in length of the measuring springs 122 is directly proportional to, and matches, the magnitude of the change in length of the main compression spring 120. The second middle portion 132B provides for moveable protection of the main compression spring 120 and measuring springs 122 during compression and extension of the main compression spring 120. The third lower portion 132C can also serve as the telescoping sleeve outer housing and includes a base which can be, or include, the bottom compression plate 119. In general, the telescoping portions can be molded, including injection molded, polymeric or composite material, and can have any features, including molded features, such as internally disposed annular ledge 164 and internally disposed annular extension 165 that permit telescoping movement in cooperation as the telescoping piston sleeve 132, but limit movement beyond desired extremes.

As discussed above, one or a plurality of springs, such as the measuring springs 122, can be electrically conductive in an inductive circuit to detect, measure, record, and/or report dimensional changes related to the chest compression plate 118. Thus, as can be understood from the description above, an embodiment of a manikin 100 apparatus can have one or more measuring springs 122 that operate in conjunction with a main compression spring 120 to monitor, measure, detect, and/or display chest compression data and provide feedback to a person doing chest compressions on the manikin 100. In an embodiment, the data include depth of compression measures. In general, therefore, the system includes a manikin, a central compression spring separating a chest compression plate and a bottom compression plate, and one or more measuring springs that are operationally configured to detect tilt of the chest compression plate during chest compression. The operational configuration can include electrical or electronic connections, and all wiring, connections, printed circuit boards, and the like. In general, the springs, including the measuring springs 122 are configured as an air core inductor, whose inductance value is governed by its physical mechanical properties according to known mathematical relationships. By converting the inductance of the coil springs to a frequency, and then converting the frequency to a distance dimension, the distance dimension, e.g., length (and changes in length) of the coil springs, can be accurately determined, recorded, and/or reported. The dimensional changes can be correlated to movement of the chest compression plate, and the depth of compression can be quantified and reported.

The measurement of the depth of the chest compressions can also be achieved by switches and sensors, as discussed below, as well as the inductive coils described above, or other methods for detecting changes in dimensions. Prior to compression, the chest compression plate 118 is a maximum distance from, and can be generally parallel to, the bottom compression plate 119. The terms “parallel to” and “maximum distance from” are used in a general sense, and not in an absolute sense. That is, for example, the “maximum distance” is intended to be the starting, pre-compression distance between a lowermost portion of the chest compression plate 118 and an uppermost portion of the bottom compression plate 119. And “parallel to” recognizes that one or both of the chest compression plate 118 and the bottom compression plate 119 can have various geometrical shapes, extensions, protrusions, and the like, but their overall configuration can approximate parallel plates.

A representative method of using the apparatus according to the system disclosed herein, can include a user positioning their hands on the chest portion of the manikin 100 in what is believed to be a correct position. After compressing the chest of the manikin 100, i.e., pressing the chest compression plate 118 toward the bottom compression plate 119, the user receives feedback, including visual, audible, or both, as to the correct positioning of their hands based on the position of the chest compression plate 118, including in an embodiment, whether the depth of the chest compression plate 118 meets or exceeds pre-set thresholds. Upon notification that such thresholds are met or exceeded, and feedback is provided, the user can reposition and try again. This method can be repeated as desired. In another embodiment, the feedback can be in the form of the sternum LEDs 152 indicating correct hand placement by, for example, having an equal number of LEDs 152 activated and visible on each side of the user's hands.

Note that the system components described are described for operation of the method, but certain components can be combined without departing from the scope of the disclosure. For example, the bottom compression plate 119 can be integral with, and indistinguishable from, a portion of the lower torso surface 114 that functionally serves as the bottom compression plate.

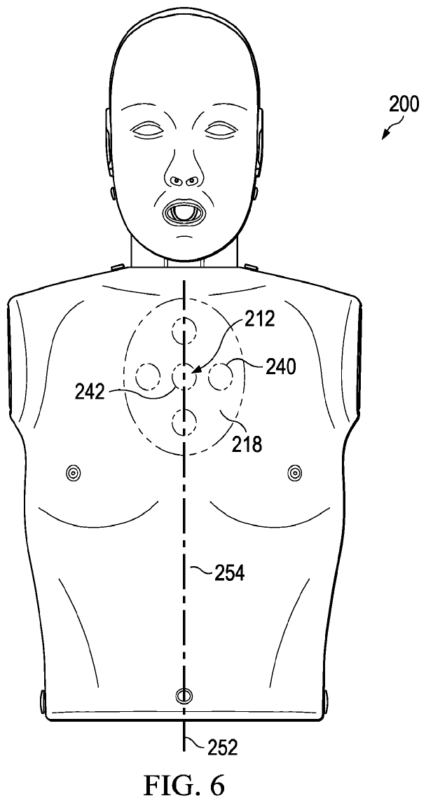

Referring now to FIG. 6, there is shown a representative embodiment of a manikin 200, in accordance with another embodiment, that, in conjunction with representative systems and methods as disclosed herein, can provide proper hand positioning feedback to a person training in CPR chest compressions. The manikin 200 can have any and all of the features described above with respect to the manikin 100. As shown in FIG. 6, the manikin 200 can have a chest compression plate 218 operationally positioned such that a central portion thereof aligns with an optimal compression force location 212. As indicated in FIG. 6, the chest compression plate 218 lies under an outer surface of the manikin 200, but in an embodiment it can lie external to the manikin external surface.

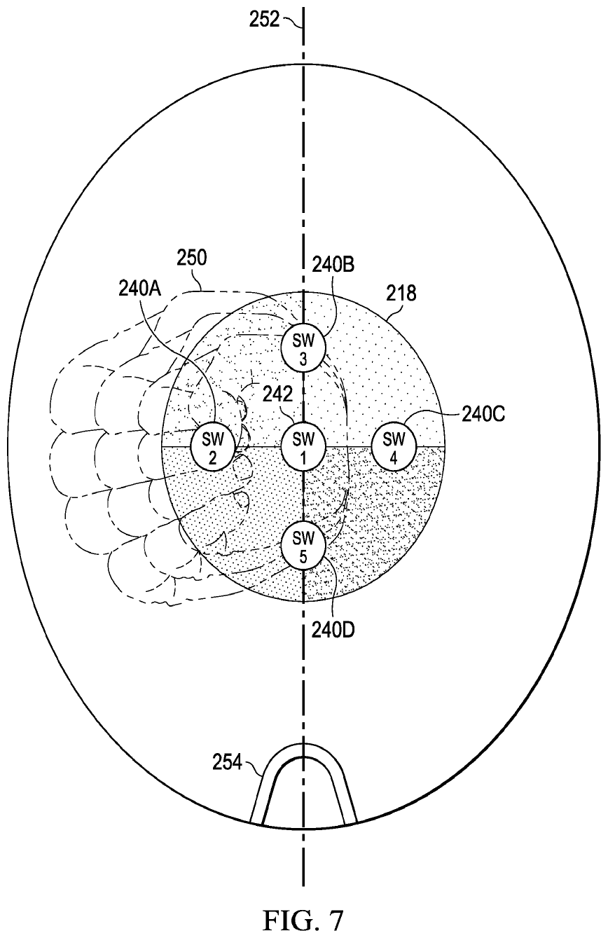

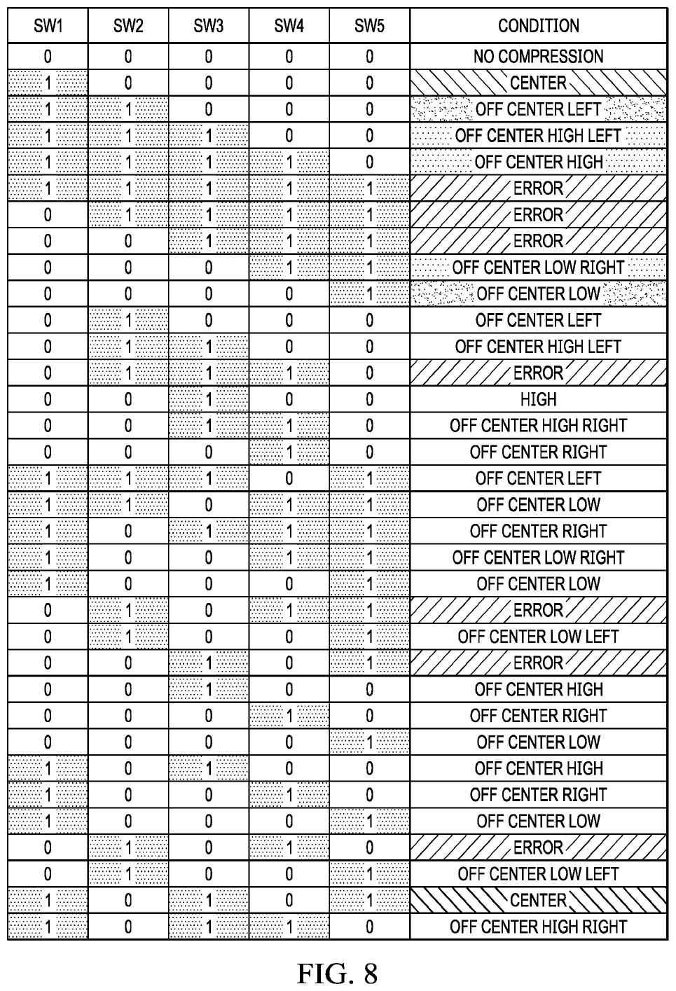

As illustrated in FIG. 7, the chest compression plate 218 has associated therewith a plurality of offset switches 240A, 240B, 240C, 240D (generally indicated as 240 in FIG. 6) that can be arranged at a distance from a central switch 242 that lies substantially aligned vertically at the optimal compression force location 212. The central switch 242 can be centrally located to correspond to the optimal compression force location 212 on manikin 200. The offset switches 240A, 240B, 240C, 240D can be disposed about the central switch 242 and can be, for descriptive purposes termed peripheral switches. Further, for descriptive purposes for understanding the general concept, the switches can be positioned with respect to an imaginary sternum centerline 252 and other anatomical features, such as the xiphoid process 254. For purposes of the chart shown in FIG. 8, the central switch 242 can be understood to be SW1 and each of the offset switches 240A, 240B, 240C, 240D can be understood to be SW2, SW3, SW4, SW5, respectively.

The switches (e.g., 240A, 240B, 240C, 240D, 242) on the manikin 200 can be electrical switches. The switches can be small membrane or tact switches, for example. Each switch can be normally open, such that if pressed above a certain pressure threshold the switch closes. A closed (or otherwise activated) switch can indicate correct hand pressure, as when only switch one 242 closes upon pressure by a user's hands 250 training in chest compressions on the manikin 200. A closed peripheral switch (e.g., 240A, 240B, 240C, 240D) closing, on the other hand, can indicate improper hand placement during chest compressions. The chart of FIG. 8 is representative of one embodiment of the feedback that can be supplied to a user during chest compressions of the manikin 200 having the switch configuration of FIG. 7. Of course, it is understood that other switch configurations, numbers, placements, and the like can be utilized without departing from the scope of this disclosure.

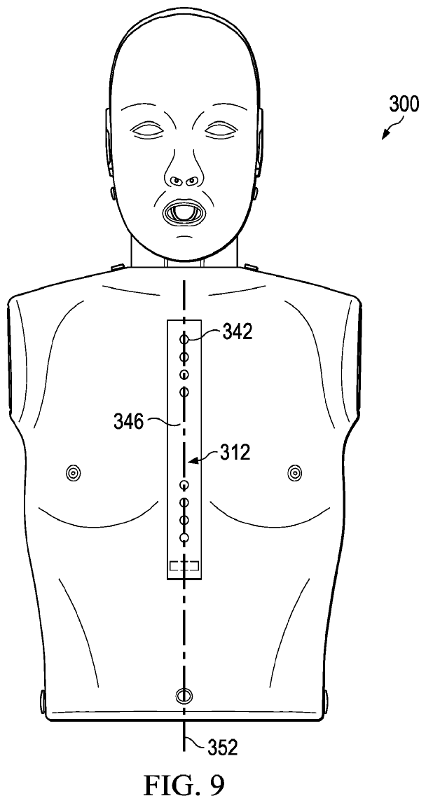

Referring now to FIG. 9, there is shown another alternative embodiment of a manikin 300 that in conjunction with representative systems and methods as disclosed herein, can provide proper hand positioning feedback to a person training in CPR chest compressions. The manikin 300 can have any and all of the features described above with respect to the manikins 100 and 200. As shown, a series of switches 342, such as membrane switches or tact switches, can be positioned linearly in alignment with an imaginary line 352 of the sternum. In the embodiment shown in FIG. 9, eight switches 342 are utilized in two groupings of four, each grouping being disposed in a spaced relationship to the optimal compression force location 312. By situating the switches 342 along the imaginary line 352 of the sternum, the switches 342 can activate upon sufficient pressure and provide feedback to the user as to the proper placement of his or her hands. For example, if only one or more of the lower four switches activate, the feedback to the user can be to reposition the hands higher up, closer to the top of the chest. Likewise, if only one or more of the upper four switches activate, the feedback to the user can be to reposition the hands lower, closer to the xiphoid process. In general, any configuration of switch activation can be correlated in training materials to provide specific feedback to a person performing chest compressions on the manikin 300.

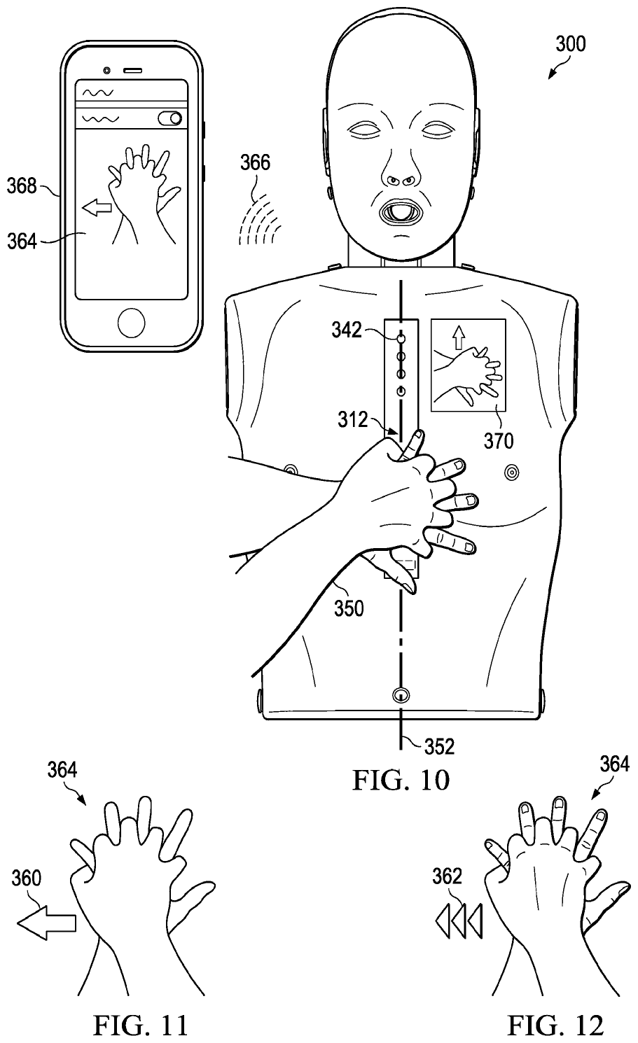

A system and method for the apparatus of the manikin 300 illustrated, together with representative feedback visuals (that can be used with any of the various embodiments disclosed) is shown in FIGS. 10-16. For example, in FIG. 10 there is represented a user's hands 350 of a user providing chest compressions with the user positioned at the manikin's right side. In FIG. 10, the user's hands 350 are placed to compress the chest at a position lower than the optimal compression force location 312. Representative visual feedback can be in the form of an image 364 presented to the user showing in which direction the user's hands 350 need to be repositioned (in this case upwardly and towards the optimal compression force location 312). The visual image can be received via wireless communication 366, such as Bluetooth® to a remote device, which can be a user's smartphone 368, or to a dedicated device component 370 of the manikin 300 such as an LCD panel and/or a plurality of LEDs designed into or onto the manikin, as described above with respect to LEDs 152 shown in FIGS. 2, 4, and 5. In FIG. 11 the visual image 364 indicates with a single arrow 360, that the user should move her hands to the left to achieve proper hand placement. The size, shape, and/or color of the arrow 360 can be proportional to the distance that the user needs to reposition their hands 350 in order to indicate the degree of movement of the user's hands is required. Likewise, the placement of the image including the arrow 360 can be on the manikin, e.g., on an LCD screen, or on a user's device, such as a smartphone. Similarly, in FIG. 12, the visual image indicates one or more pointers 362 the user should move her hands to the left to achieve proper hand placement. The number (as shown below), size, shape, and/or color of the pointers 362 can indicate the degree of movement of the user's hands is required.

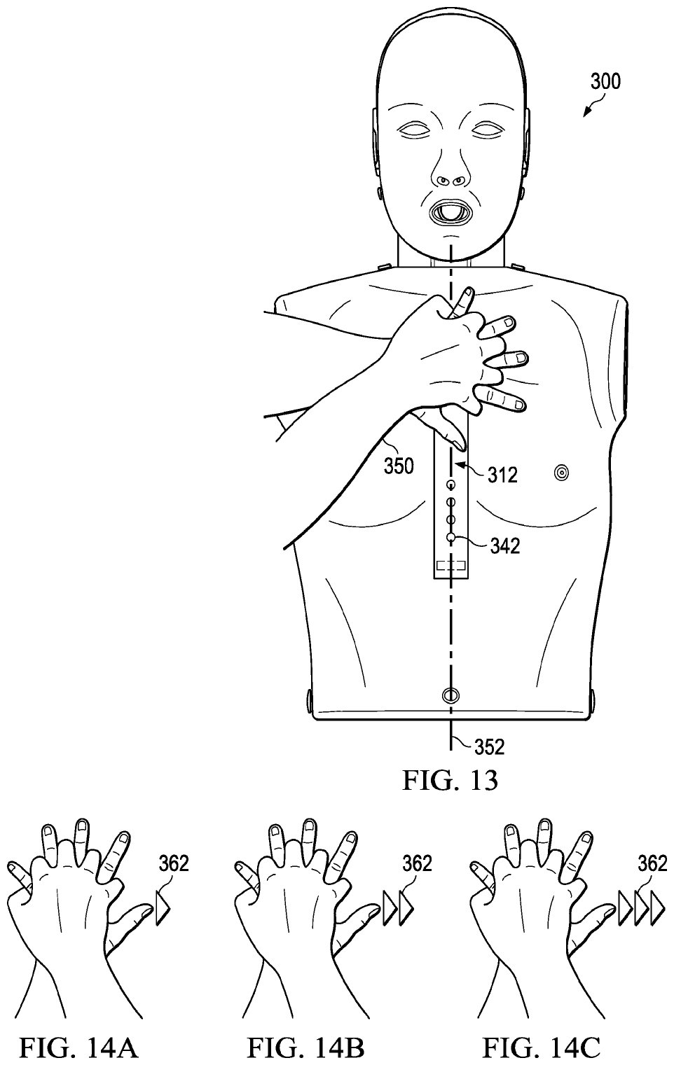

In FIG. 13, the user's hands 350 are shown to be placed at a location that compresses the chest at a position that is higher than the optimal compression force location 312. Representative visual feedback can be in the form of an image presented to the user showing in which direction he or she should move her hands. The visual image can be received via wireless communication to a user's smartphone, or other device, or to a dedicated device component of the manikin 300. As shown in FIG. 14A-C, the visual images can show progressively greater indications of relative hand movement for proper placement as a function of the distance that the user's hands 350 are from the optimal compression force location 312. That is, a single pointer 362 as in FIG. 14A indicates slight hand repositioning to the right. Two pointers 362 can indicate moderate repositioning of the hands to the right. Three pointers 362 can indicate a significant shift of the hands to the right. The size, shape, and/or color of the pointers 362 can also be utilized to indicate the degree of movement of the user's hands is required.

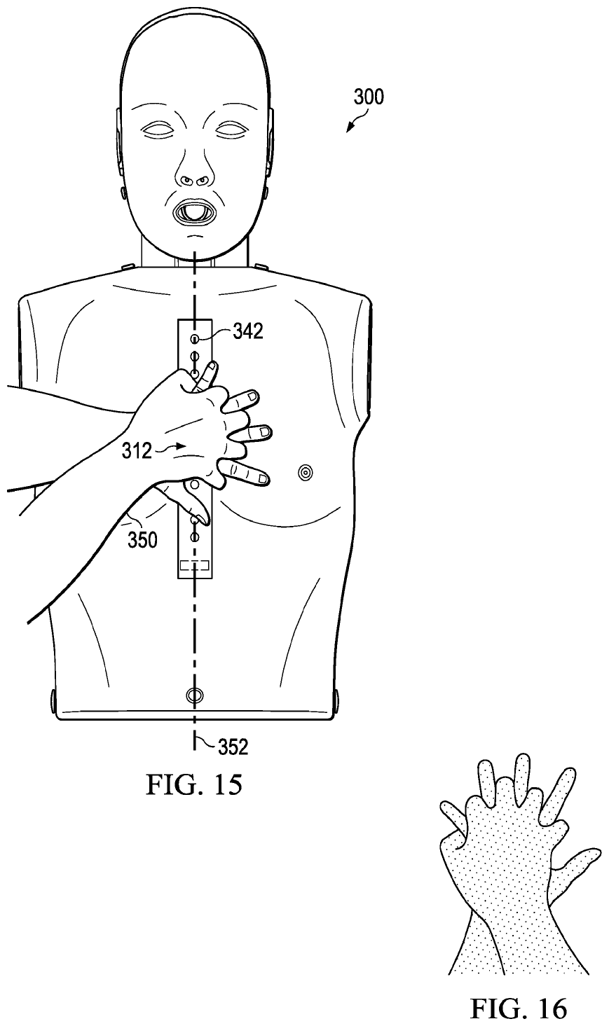

Referring now to FIGS. 15 and 16, a proper placement of the user's hands, as shown in FIG. 15, can result in a visual indication, such as the one shown in FIG. 16 that has no arrows, i.e., no need for movement for proper hand positioning. Additionally, the image, such as the one shown in FIG. 16, can have color coding, such as being shown in the color green, for additional immediate confirmation that the hand positioning is correct.

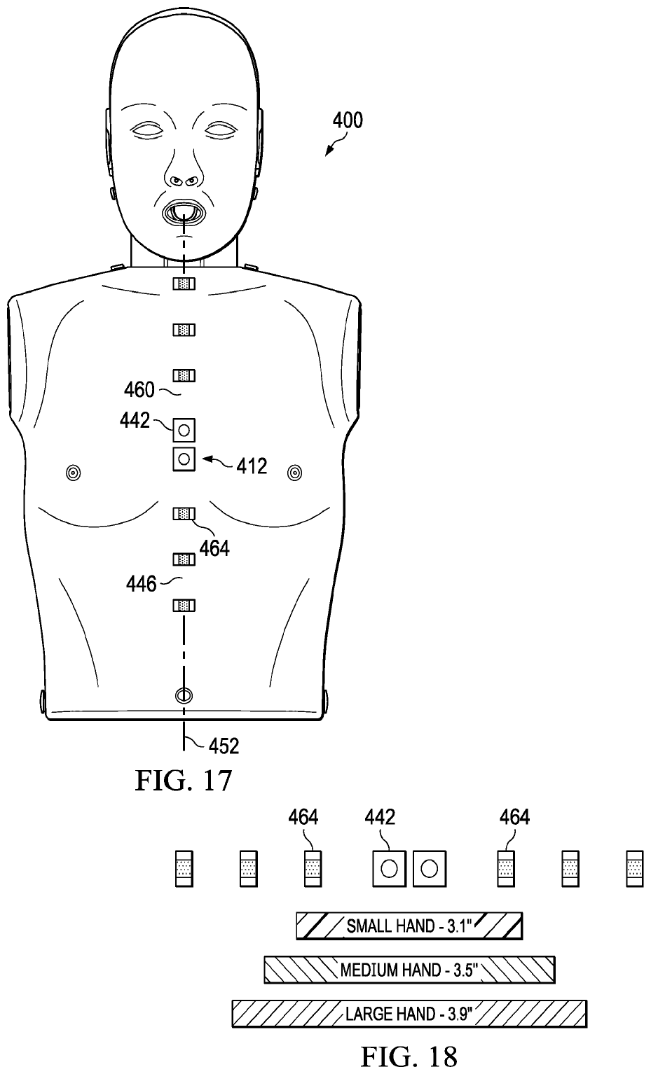

Referring now to FIG. 17, there is shown a representative embodiment of a manikin 400 in accordance with yet another embodiment that in conjunction with representative systems and methods as disclosed herein, can provide proper hand positioning feedback to a person training in CPR chest compressions. The manikin 400 can have any and all of the features described above with respect to the manikins 100, 200 and 300. As shown, one or more switches 442, such as membrane switches or tact switches, can be positioned linearly in alignment with an imaginary line 452 of the sternum at the optimal compression force location 412. Two switches 442 are shown in FIG. 17. In an embodiment, a second switch 442 (or more) can be included for redundancy if the reliability of switches are a concern. In addition to one or more switches 442, a series of visual indicators, such as LED lights 464 can be positioned in a spaced relationship and in line with the imaginary line 452 of the sternum. In the embodiment illustrated, two groups of three LED lights 464 are shown, three above the optimal compression force location 412, and three below. The LED lights can be placed below the “skin” surface of the manikin 400 so that they are not visible unless, and until, they light up. In operation, when a user presses for a compression along the sternum of the manikin 400, the switch(es) 442 would be activated and light one or more LEDs also spaced out along the length of the sternum. In an example training scenario, if compression occurs in the right location, equal numbers of LED lights 464 on each side of the switch(es) 442 can illuminate. Likewise, in an example training scenario, a student would need to ensure that the number of LEDs showing on either side of their hand location would be the same. If not the same, student would need to correct hand placement. In general, any configuration of LED activation can be correlated in training materials to provide specific feedback to a person performing chest compressions on the manikin 400. As shown in FIG. 18, which is a schematic depiction of a representative relative placement of switches and LEDs for the manikin 400, the correct placement of the hands during compression can vary depending on the size of the person's hands who is doing the compressions.

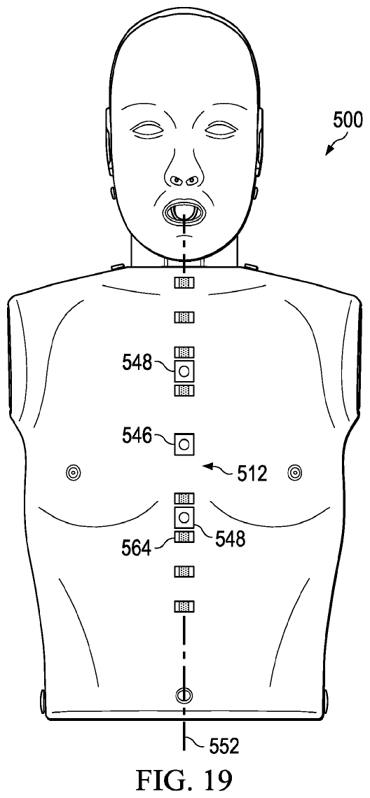

Referring now to FIG. 19, there is shown a representative embodiment of a manikin 500 in accordance with yet another embodiment that in conjunction with representative systems and methods as disclosed herein, can provide proper hand positioning feedback to a person training in CPR chest compressions. The manikin 500 can have any and all of the features described above with respect to the manikins 100, 200, 300 and 400. As shown, a central switch 546 can be disposed in the center of a generally linear strip of switches and LED indicators, with the central switch being disposed over the optimal compression location 512 of the manikin. Additional switches, such as the two outer switches 548 can be substantially equally spaced to either side of the center switch 546 and on opposite sides of a center of compression area 512. In addition to the switches of manikin 500, a series of visual indicators, such as LEDs 564 are present in a linear, spaced apart array. The LEDs 564 can be color coded as desired, and can be bi-colored to light in specific colors for specific purposes, as described below.

The methodology involved with the manikin 500 is that when a user presses for a compression along the sternum of the manikin 500, the center switch 546 would be activated if the user's hand placement is correct. In this case, a series of bi-colored LEDs to either side of the user's hands could illuminate and stay solid, for example as blue, indicating a positive, correct hand position, for a specified period of time. If the hand position is to the right or to the left of center, that is offset to the right or to the left (depending on which side of the manikin the student is positioned), one of the outer switches 548 could activate, which would cause the LEDs to operate differently to show that something is wrong and needs corrected. In general, any configuration of switches and LED activation can be correlated in training materials to provide specific feedback to a person performing chest compressions on the manikin 500.

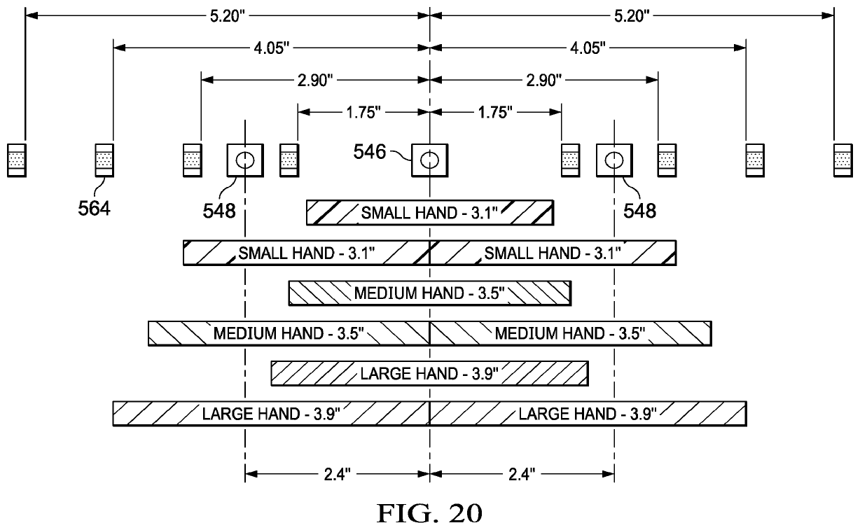

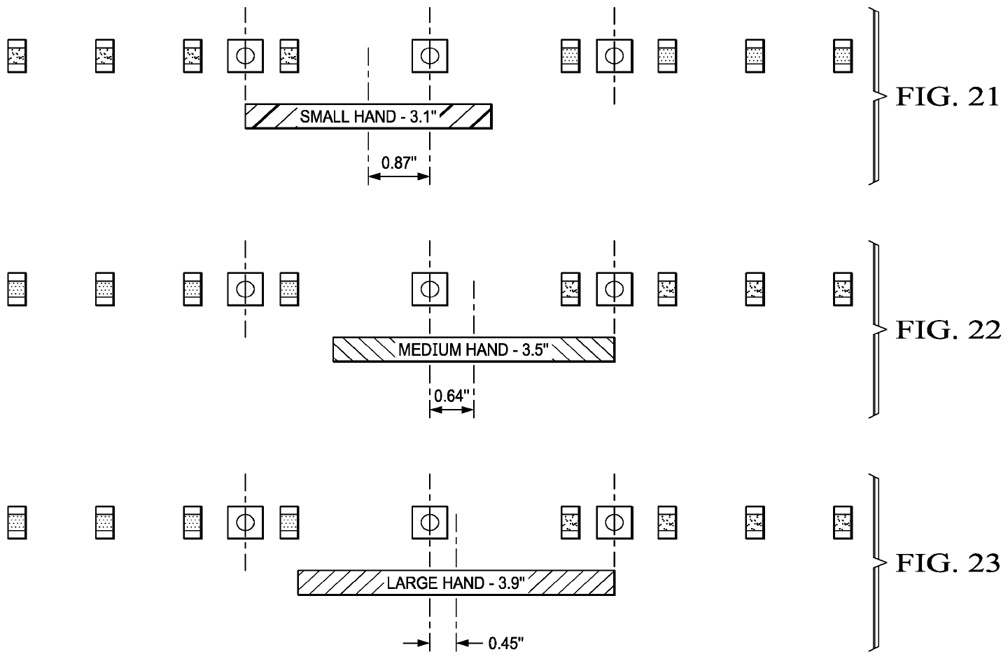

FIG. 20 shows a schematic representation of an example placement, including representative dimensions, of switches and LEDs for the manikin 500, as described above, without numbering for clarity, focusing on the relative placement and representative dimensions. The schematic depiction also shows relative hand sizes, and relatively offset relationships of hand sizes that may be important in detecting improper hand placement during chest compressions of the manikin 500. FIGS. 21-23 show representative schematic representations tolerance ranges for improper hand positions for the manikin 500, including for small hands (FIG. 21), medium size hands (FIG. 22), and large size hands (FIG. 23).

As discussed above, dimensional changes in the length of components such as coil springs can be measured, recorded, and reported. Additionally, as discussed above, detecting these dimensional changes can be useful in training against uneven pressing of the chest plate of a CPR manikin. Further, as discussed above, this dimensional change can be determined by taking advantage of the electrical properties of a conductive coil spring in an electrical circuit, particularly the property of inductance. Such properties and how they are leveraged in the current apparatus for systems and methods of CPR training are disclosed. For example, the difference between the respective length changes of two springs in a system, as discussed above, can be utilized to determine an uneven, i.e., a tilted, condition during compression of a chest plate in a CPR manikin. Likewise, as more fully described below, such length changes can be utilized to determine a distance dimension change related to depth measurement during compression of a chest plate in a CPR manikin.

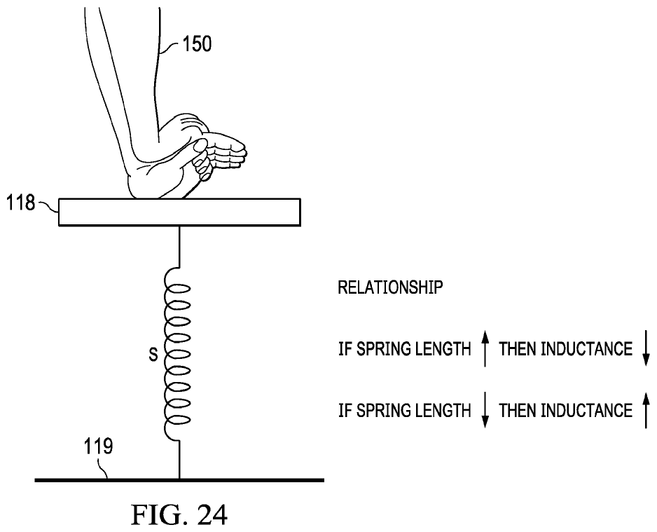

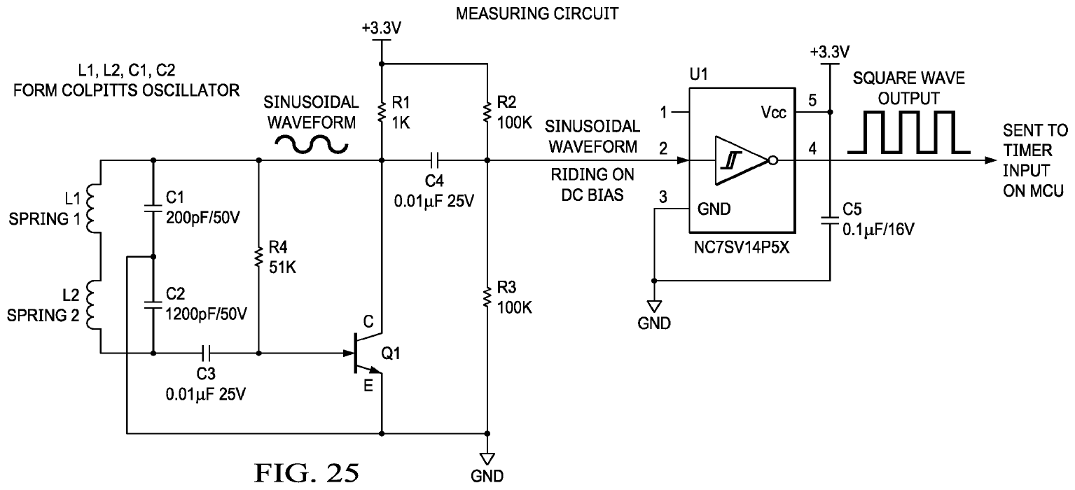

Referring now to FIG. 24, there is shown a schematic representation of a coil spring S operationally connected to a chest compression plate 118 and a bottom compression plate 119. In general, the coil spring S is an air core inductor, whose inductance value is governed by its physical mechanical properties. By converting the inductance of the coil spring S to a frequency, and then converting the frequency to a distance dimension, the distance dimension, e.g., length (and changes in length) of the coil spring S, can be accurately determined, recorded, and/or reported As indicated in FIG. 21, the basic relationship between spring S length and inductance is linear, with inductance being proportional to the length of the spring S coil. As shown, as spring length increases inductance decreases, and as spring S length decreases, inductance increases. Thus, in operation in the apparatus and system disclosed herein, a coil spring S, which can be a main compression spring 120 and/or one of the plurality of measuring springs 122, or other spring, can be utilized to measure dimensions and dimensional changes during chest compressions on a manikin. As the chest compression plate 118 is compressed during a training chest compression, any of the various springs associated with the chest compression plate 118 can change length, and thus inductance, and the inductance can be converted to a distance dimensional change.

The conversion of an inductance measure to a distance measure is accomplished by first converting inductance to a frequency measurement and then converting the frequency measurement into a linear dimension, e.g., length which correlates to distance. Inductance can be converted to a frequency waveform by utilization of a resonant circuit, such an inductor/capacitor (LC) oscillator circuit using a spring as an inductor component.

In an embodiment, the LC oscillator can use an NPN transistor to keep the resonant frequency of the circuit constant as a voltage powering the circuit varies. Thus, for example, for an apparatus powered by batteries, as the battery voltage drops, the resonant frequency can remain stable. A Colpitts oscillator tank circuit is an example of an LC oscillator comprised of an inductor and two capacitors forming a voltage divider. The output of such an oscillator can be taken from the collector of the NPN transistor and is a sinusoidal signal. The sinusoidal signal can be converted to a digital square wave signal, such as be feeding it through an analog to digital converter, such as a Schmidt trigger to buffer and convert it.

In the disclosed embodiments utilizing springs that change length during operation, the LC oscillator can be a modified Colpitts circuit, such that the inductors are not fixed, but can be variable. An example LC oscillator circuit in which a fixed inductor is replaced by a variable inductor in the LC circuit is shown in FIG. 25, which includes two variable inductors indicated as Spring 1 and Spring 2.

By way of representative example, referring to FIG. 25, a system utilizing two measuring springs 122 as variable inductors L1/L2, such as described herein, can include capacitors C1 and C2 as part of a modified Colpitts oscillator. R1, R4, and Q1 is the transistor network, and R1 keeps injecting current into the oscillator to keep it oscillating. C3 capacitively couples the Colpitts oscillator to the base of the transistor which drives the circuit. The output of the oscillator is a sinusoidal that can be converted to a square wave to be fed to the microcontroller unit (MCU) were frequency can be measured. In an embodiment, the sinusoidal waveform on a DC bias is fed into an inverting Schmidt trigger gate to convert it to a square wave, which conditions the signal so the timer input on the MCU can measure the frequency. In an embodiment a factory calibration of a manikin utilizing the above-described circuit can include a two-point calibration routine to reduce or remove inaccuracies due to component tolerances.

Dimensional changes in the length of coil springs in a manikin of the present disclosure can be beneficially detected to measure, record, and/or report the depth of a chest compression when pressing of the chest plate of a CPR manikin.

The dimensional change of the length of the measuring springs 122 can be determined by the LC oscillator circuit described herein. Thus, the dimensional shortening of the measuring springs 122 can be detected, measured, recorded, and/or reported as a depth of compression of the main compression spring 120 during chest compressions on a manikin, such as the manikin 100 referred to in FIG. 3, which also shows depth measure springs 122 interior to the main compression spring 120. Representative visual feedback can be in the form of an image presented to the user showing the depth of chest compressions, including under or over compression and visual indications for correction. The visual image, or data or instructions for causing the display of the visual image, can be received via wireless communication to a user's smartphone, or other device, or to a dedicated device component of the manikin such as an LCD panel and/or a plurality of LEDs designed into the manikin, as described herein. In addition to depth compression detected as length dimension changes, the LC oscillator circuit described herein additionally allows the detection of absolute depth compression of the chest compression plate 118 at varying points in time, whether the chest compression plate is in motion or not, and static position. Thus, in a training scenario, depth of compression, rate of compression, recoil, and “hands off” time can be determined, recorded, and/or reported.

In an embodiment of a manikin for measuring depth compression during chest compressions, the system can include audio and/or visual feedback to indicate a chest compression of between about 1 inches and about 3 inches, or between about 1.5 inches and about 2.5 inches, or between about 2 inches (5 cm) and about 2.5 inches (6 cm).

Other components useful for measuring dimensional changes of various components of a manikin can be incorporated in addition to, or in some cases, instead of, the disclosed components. For example, accelerometers can be utilized to measure maximum depth of compression during chest compressions. Additionally, Hall Effect devices with an IC/magnet pairing, photo devices with a transmitter/receiver pair, time of flight (TOF) sensors, and linear actuators can be implemented to measure dimensional changes in distance of one or more portions of a chest compression plate to detect depth of compression and/or uneven compression. In an embodiment, infrared (IR) sensor could be used with, or instead of, the measuring springs 122 discussed above, to detect and measure dimensional differences from side to side for the chest compression plate, and the detected dimensional differences can be extrapolate to a tilt measure, and reported to a person training on the CPR manikin. In another embodiment, multiple small, or a single large, pressure sensitive pad(s) could be disposed on, in, over, or otherwise juxtaposed with, the chest compression plate, and the pressure detected thereon could be analyzed with respect to magnitude and location, and extrapolated to a tilt measure of the chest compression plate. In an embodiment utilizing a pressure sensitive pad, pressure detection, measurement, and/or recording is accomplished essentially via electronic “switches,” which can be utilized in the system and method of the disclosure similarly to the mechanical switches described above. In an embodiment, one or more tilt switches, such as tilt ball or tilt mercury switches, in which lie conductive poles that can be activated when the conductive ball or mercury contacts them.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A CPR training manikin, the CPR training manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression spring joining in compression resistant separated positions a bottom compression plate and a chest compression plate; and
the chest compression plate residing under an interior surface of the upper torso surface and being compressible against the main compression spring to simulate compressions of a human chest during CPR, wherein a plurality of LED lights are aligned linearly on the chest compression plate in a region and in an orientation corresponding to the sternum axis.

2. The CPR training manikin of claim 1, wherein the upper torso surface comprises latex-free vinyl.

3. The CPR training manikin of claim 1, wherein the upper torso surface comprises molded features visually corresponding to a sternum of a human torso.

4. The CPR training manikin of claim 1, wherein the lower torso surface and the upper torso surface are pivotally joined to define a clamshell configuration.

5. The CPR training manikin of claim 1, wherein the chest compression plate has a size and shape that mimics a human rib cage.

6. The CPR training manikin of claim 1, wherein the plurality of LED lights are mounted on a sternum PCBA joined to the chest compression plate.

7. The CPR training manikin of claim 1, wherein the upper torso surface is translucent in the region corresponding to a placement of the plurality of LED lights.

8. The CPR training manikin of claim 1, wherein the plurality of LED lights are powered by a battery source, the battery source being disposed in the interior portion.

9. A CPR training manikin, the CPR training manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression coil spring joining in compression resistant separated positions a bottom compression plate and a chest compression plate, the main compression coil spring having a spring axis oriented generally orthogonal to and intersecting the sternum axis;
the chest compression plate residing under an interior surface of the upper torso surface and being compressible against the main compression coil spring to simulate compressions of a human chest during CPR; and
at least one electrically conductive measuring spring disposed in the interior of the main compression coil spring, the at least one electrically conductive measuring spring being connected in an electrical circuit configured to measure a change in inductance with a corresponding change in a length of the at least one electrically conductive measuring spring.

10. The CPR training manikin of claim 9, wherein the upper torso surface comprises latex-free vinyl.

11. The CPR training manikin of claim 9, wherein the upper torso surface comprises molded features visually corresponding to a sternum of a human torso.

12. The CPR training manikin of claim 9, wherein the lower torso surface and the upper torso surface are pivotally joined to define a clamshell configuration.

13. The CPR training manikin of claim 9, wherein the chest compression plate has a size and shape that mimics a human rib cage.

14. The CPR training manikin of claim 9, comprising two measuring springs.

15. The CPR training manikin of claim 9, wherein the change in inductance is analyzed and reported to an electronic device as a measure of compression.

16. The CPR training manikin of claim 9, further comprising a plurality of LED lights aligned linearly on the chest compression plate in a region and in an orientation corresponding to the sternum axis.

17. A CPR training manikin, the CPR training manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression coil spring joining in compression resistant separated positions a bottom compression plate and a chest compression plate, the main compression coil spring having a coil spring axis oriented generally orthogonal to and intersecting the sternum axis;
a telescoping piston sleeve enclosing the main compression coil spring;
the chest compression plate residing under an interior surface of the upper torso surface and being compressible against the main compression coil spring to simulate compressions of a human chest during CPR; and
at least one electrically conductive measuring spring disposed in the interior of the main compression coil spring, the at least one electrically conductive measuring spring being connected in an electrical circuit configured to measure a change in inductance with a corresponding change in a length of the at least one electrically conductive measuring spring.

18. The CPR training manikin of claim 17, wherein a portion of the telescoping piston sleeve is shaped to hold in position the chest compression plate and one end of the main compression coil spring.

19. The CPR training manikin of claim 17, wherein the change in inductance is analyzed and reported to an electronic device as a measure of compression of the main compression coil spring.

20. The CPR training manikin of claim 17, further comprising a plurality of LED lights aligned linearly on the chest compression plate in a region and in an orientation corresponding to the sternum axis.
